(19) United States
(12) Patent Application Publication
(10) Pub. No.: US 2005/0251495 A1
(43) Pub. Date: Nov. 10, 2005

(54) System and method for unified file management

(75) Inventor: Rob Woollen, San Francisco, CA (US)

Correspondence Address: FLIESLER MEYER, LLP, FOUR EMBARCADERO CENTER, SUITE 400, SAN FRANCISCO, CA, 94111, US

(73) Assignee: BEA Systems, Inc., San Jose, CA (US)

(21) Appl. No.: 10/961,261

(22) Filed: Oct. 8, 2004

Related U.S. Application Data
(60) Provisional application No. 60/568,606, filed on May 6, 2004.

(51) Int. Cl. G06F 7/00

(52) U.S. Cl. 707/1

(57) ABSTRACT

In accordance with one embodiment of the present invention, a system for extracting and loading files and resources provides a uniform file interface that is configured to provide access to multiple types of files. Containers provide resource requests to the uniform file system interface, which interprets the requests, determines how the requested resource should be extracted, and extracts the resource.

### PRIORITY CLAIM

The present application is a nonprovisional of U.S. patent application Ser. No. 60/568,606, filed on May 6, 2004, entitled SYSTEM AND METHOD FOR UNIFIED FILE MANAGEMENT, Inventor: Rob Woolen, Attorney Docket No. BEAS-1588US0, the contents of which are incorporated by reference in their entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates generally to systems, methods, and computer readable media for accessing files within a Java server. The present invention relates more specifically to the creation and implementation of a file interface for accessing differing types of modules within the Java server.

### BACKGROUND OF THE INVENTION

Since its inception in 1995, the Java programming language has become increasingly popular. Java, which is an interpreted language, enabled the creation of applications which could be run on a wide variety of platforms. This ability to function across a variety of different client platforms and Java's relatively easy implementation of network applications has resulted in its use in endeavors as basic as personal webpages to endeavors as complex as large business-to-business enterprise systems.

As Java has become more commonplace, a wide variety of tools and development platforms have been created to assist developers in the creation and implementation of Java applications. These development platforms have usually been built around an application server program which provides a common interface for accessing internal data and resources.

As these server implementations have become more complex, they have offered differing and varying mechanisms for retrieving the various resources that the server and its containers must access. However, these mechanisms have developed organically, resulting in an incoherent patchwork of different means for retrieving resources for use by applications within a Java server. For example, the differing file structures such as archives, exploded archives, and split-directory applications each require their own implementations to be extracted by a container.

Additionally, as new resources and file types have developed, existing file retrieval mechanisms have been modified to access the new resources and file types, even when the retrieval mechanisms are not well configured to access the file types. For example, the VirtualJarFile method is designed to retrieve archives, but is also used for other file structures, for which it is inefficient or inappropriate. Furthermore, the code for extracting different files is thus spread throughout the different containers, complicating the file extraction process and making the implementation of intelligent extraction code more difficult.

FIG. 1 illustrates one embodiment of a file extraction system as practiced in the prior art. A container 120 within a Java server accesses files stored on a file storage 180. The container 120 is preferably a conventional container that provides runtime support and deployment assistance for components. In one embodiment, the container is associated with particular types of components such as Enterprise Java Beans, applets, or web applications, and provides services that are particular to those components.

The file storage 180 is a storage device on a computer system running the Java server. The file storage 180 includes a file system organizing and maintaining access to differing files stored for the server. The storage 180 includes files stored as archives 185, split directory applications 195, and exploded archives 190. While these three file types are illustrated herein, it should be noted that in alternate embodiments, any number of file types can be used.

The archives 185 are groups of modules that have been combined into a single archive file. In one embodiment, the modules that are grouped together in an archive file are associated with a single application. In alternate embodiments, the modules are sections of separate applications. In some embodiments, the modules are compressed when combined into a single file. In alternate embodiments, the modules are uncompressed. The archives can be Enterprise ARchive files (EARs), Java ARchive files (JARs), Web application ARchives (WARs) or any other archives. In one embodiment, the archives 185 must be extracted before they can be deployed.

The file storage 180 additionally includes split directory applications 195. The split directory applications are applications having build and source files spread over differing directories previous to deployment. The various components are typically stored in top-level directories for later access. Deployment descriptors such as application.xml files are stored in a separate directory.

The file storage additionally includes exploded archives 190. The exploded archives 190 are file groups containing files that would otherwise be stored in JAR, EAR, or WAR files that have been extracted. In some embodiments, exploded archives are used for modules that are being modified and tested, since the modules can be modified directly, rather than needing to be exploded and then rearchived.

Each of the file types has an associated VirtualJarFile 130, 140, 150 class maintained by the container 120. The VirtualJarFiles 130, 140, 150 are classes responsible for file management and extraction. Each VirtualJarFile class 130, 140, 150 is responsible for extracting deployment descriptors as well as other resources from the files. Each VirtualJarFile class is separately configured for its file type and is designed to accept requests for resources and find the resources within files of its file type. The container also uses classloaders/classfinders 135, 145, 155 to find resources and classes within the varying file types and return them to the container. As with the VirtualJarFile classes, the classloaders/classfinders 135, 145, 155 are separately configured for their associate file types.

Such an arrangement for accessing modules is highly inefficient as it requires multiple file extraction classes that are disorganized and difficult to maintain. What is needed is an improved arrangement for accessing stored modules.

### BRIEF DESCRIPTION OF THE DRAWINGS

FIG. 1 illustrates one embodiment of a file extraction system as practiced in the pior art.

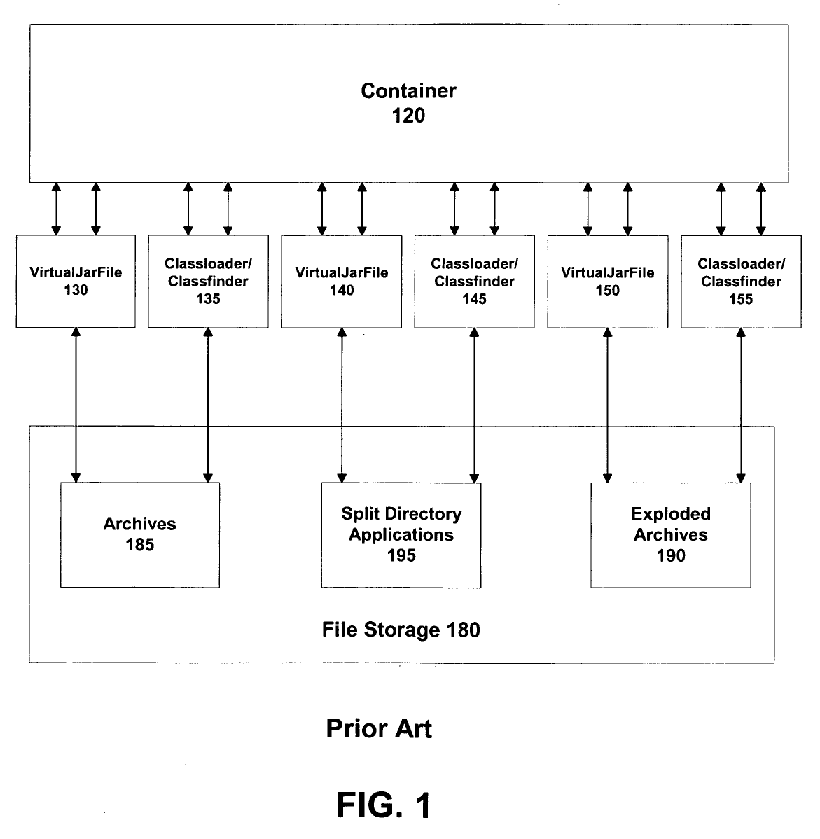

FIG. 2 illustrates one embodiment of a file extraction system in accordance with one embodiment of the present invention.

FIG. 3 is a flow chart illustrating one embodiment of a process for file retrieval performed by a uniform file interface.

FIG. 4 is a table illustrating one embodiment of extraction actions that can be taken by a uniform file interface.

### DETAILED DESCRIPTION

In accordance with one embodiment of the present invention, a system for extracting and loading files and resources provides a uniform file interface that is configure to provide access to multiple types of files. Containers provide resource requests to the uniform file system interface, which interprets the requests, determines how the requested resources should be extracted, and extracts the resources.

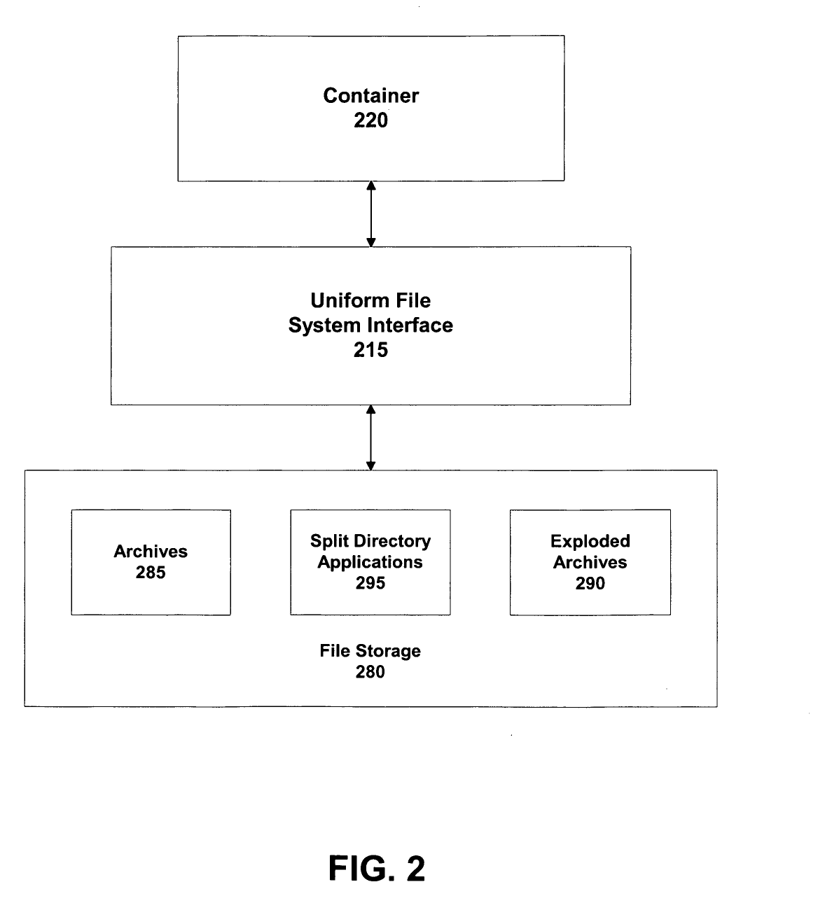

FIG. 2 illustrates one embodiment of a file extraction system in accordance with one embodiment of the present invention. A container 220 within a Java server accesses files stored on a file storage 280 through a uniform file system interface 215. The container 220 is a container that provides runtime support and deployment assistance for components. In one embodiment, the container is associated with particular types of components such as Enterprise Java Beans, applets, and web applications, and provides services that are particular to that component.

The file storage 280 is preferably a storage device on a computer system running the Java server. The storage 280 includes a file system organizing and maintaining access to differing files stored for the server. The file storage 280 includes files stored as archives 285, split directory applications 295, and exploded archives 290. While these three file types are illustrated herein, it should be noted that in alternate embodiments, any number of file types can be used.

The archives 285 are groups of modules that have been combined into a single archive file. In one embodiment, the modules that are grouped together in an archive file are associated with a single application. In alternate embodiments, the modules are sections of separate applications. In some embodiments, the modules are compressed when combined into a single file. In alternate embodiments, the modules are uncompressed. The archives can be Enterprise ARchive files (EARs), Java ARchive files (JARs), Web application ARchives (WARs), Resource ARchives (RARs) or any other archives. In one embodiment, the archives 185 must be extracted before they can be deployed.

The file storage 280 additionally includes split-directory applications 195. The split directory applications are applications having build and source files spread over differing directories previous to deployment. The various components are typically stored in top-level directories for later access. Deployment descriptors such as application.xml files are stored in a separate directory.

The file storage additionally includes exploded archives 290. The exploded archives 290 are file groups containing files that would otherwise be stored in JAR, EAR, or WAR files that have been extracted. In some embodiments, exploded archives are used for modules that are being modified and tested, since the modules can be modified directly, rather than needing to be exploded and then rearchived.

The uniform file interface 215 is configured to receive requests for resources from the containers, determine how to extract the resources from each of the file types 285, 290, 295 and return the requested resource to the container 220. The requests submitted to the uniform file interface 215 are abstracted and do not require the container 220 to be aware of the structure of the file types. In one embodiment, the container 220 submits a file request to the uniform file interface 215 containing a module Uniform Resource Identifier (URI) and a path within a resource. One embodiment of such a request would use the template below:
<module-uri>#<resource path>

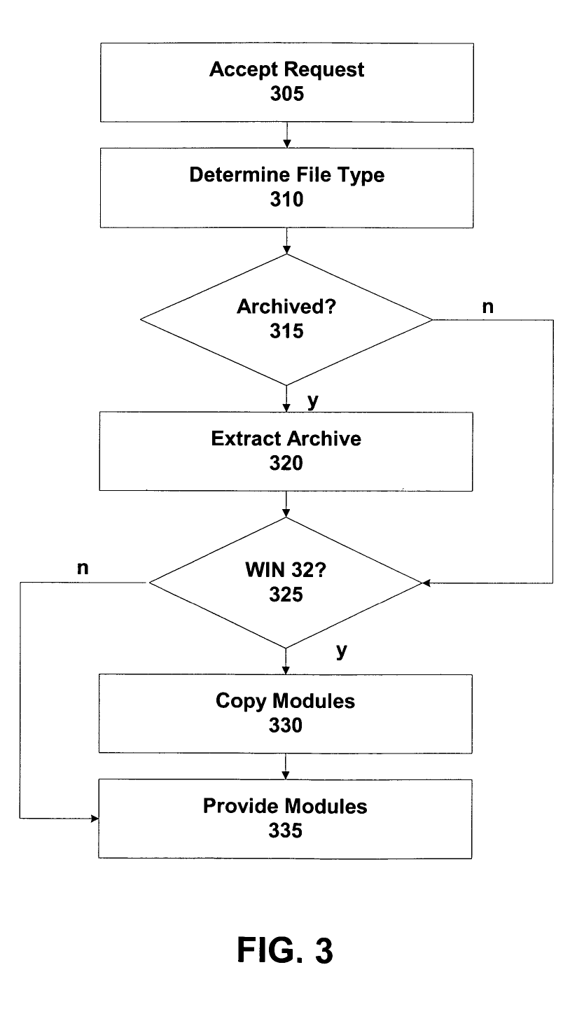

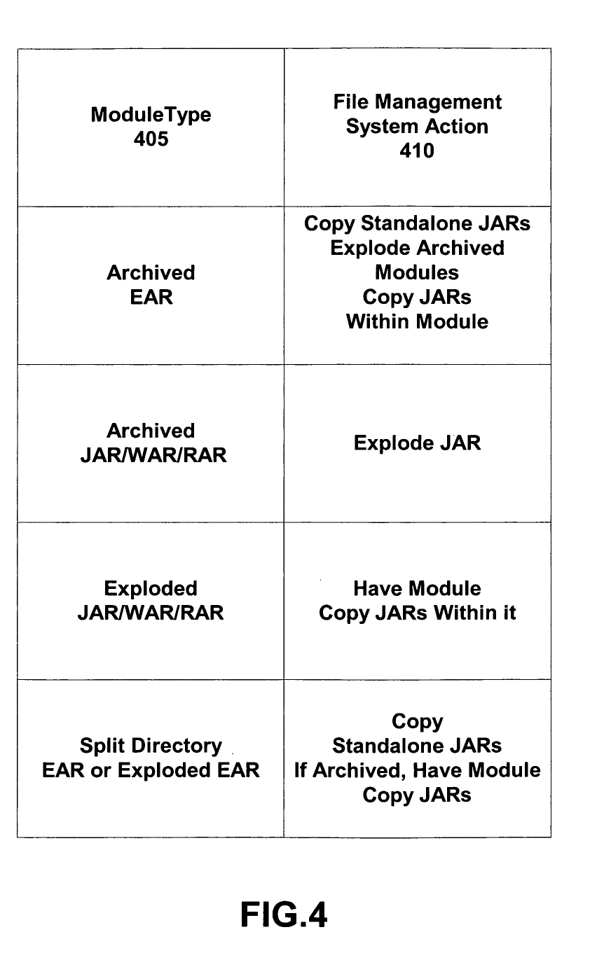

In alternate embodiments, the uniform file interface can accept requests submitted in any number of forms. The uniform file interface accepts the requests and retrieves the requested files. The steps taken for file extraction are described in greater detail with respect to FIG. 3 and FIG. 4.

In some embodiments, the uniform file interface can implement a caching feature. Upon extracting a file, the uniform file interface 215 stores a cache of the file for a predetermined amount of time. If the container 220 requests a module within a recently extracted file, the uniform file interface 215 determines whether the file has changed. If the file has not changed, the uniform file interface 215 returns the cached version. If the file has not changed, the uniform file interface extracts the file again, caches the new version, and returns the requested module.

FIG. 3 is a flow chart illustrating one embodiment of a process for file retrieval performed by a uniform file interface 215. In step 305, the uniform file interface 215 receives a request from a container 220 to retrieve a module. As discussed above, the request preferably includes a URI and resource path. For example, if the container 220 was an EJB container, and was attempting to read an ejb-jar.xml descriptor from a file titled “AccountsEJB.jar” , it would submit the following command:
GetResourceAsStream (“AccountsEJB.jar#META-INF/ejb-jar.xml)

In step 310, the uniform file interface determines the file type. This action can be performed by examining an extension in the resource request. In step 315, the uniform file interface 215, determines whether the file is archived, preferably by checking the file type. If the file is not archived, the process jumps to step 325, which is discussed below.

If the file is archived, the uniform file interface moves to step 320 and extracts the archive, breaking the single archive file into its component modules. In step 325, the uniform file interface 215 checks whether the file system on which it is running is a win32 system. If the system is not a win32 system, the uniform file interface 215 jumps to step 335. If the system is a win32 system, the uniform file interface moves to step 330 and creates extra copies of the modules. Doing so prevents sharing violations on the win32 system. This step can also be taken for any operating system that has limits on the number of processes that can access a module at once. The copying can be performed by the uniform file interface 215 or by the modules themselves. In step 325, the uniform file interface provides the requested modules to the container that submitted the request.

FIG. 4 is a table illustrating one embodiment of extraction actions that can be taken by a uniform file interface. The table includes a list of module types 405 and their associated retrieval actions 410. If the module is within an archived EAR, the uniform file interface explodes (decompresses and splits) the archive, explodes any modules within the archive, and copies the modules. Any requested modules are then returned to the container 220. If the requested module is within an archived JAR, WAR, or RAR the requested module is exploded by the uniform file interface.

If the requested module is an exploded or split directory EAR, the uniform file interface first copies the module to insure that it is accessible by other processes. In one embodiment, this copying is only performed on win32 systems. If the module is a stand alone EAR, it is copied by the uniform file interface. If the module is archived, it is first exploded, and then directed to copy any modules, such as libraries, within it.

If the requested module is an exploded JAR, RAR, or WAR, the module is directed to copy any JARs within it, such as libraries, to create extra copies and prevent sharing violations.

Other features, aspects and objects of the invention can be obtained from a review of the figures and the claims. It is to be understood that other embodiments of the invention can be developed and fall within the spirit and scope of the invention and claims.

The foregoing description of preferred embodiments of the present invention has been provided for the purposes of illustration and description. It is not intended to be exhaustive or to limit the invention to the precise forms disclosed. Obviously, many modifications and variations will be apparent to the practitioner skilled in the art. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

In addition to an embodiment consisting of specifically designed integrated circuits or other electronics, the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application specific integrated circuits or by interconnecting an appropriate network of conventional component circuits, as will be readily apparent to those skilled in the art.

The present invention includes a computer program product which is a storage medium (media) having instructions stored thereon/in which can be used to program a computer to perform any of the processes of the present invention. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications.

Included in the programming (software) of the general/specialized computer or microprocessor are software modules for implementing the teachings of the present invention.

1. A method for managing access to modules in a Java server, the method comprising:
generating a file interface in the Java server, the file interface configured to receive requests to retrieve modules stored in files, the files having a plurality of file types;
receiving at the file interface a request from a container for a module, the request including a resource identifier for the module and a path for the module;
determining a retrieval action to be performed for a file type of a file storing the module; and
performing the retrieval action on the file storing the module.

2. The method of claim 1, wherein the retrieval action comprises exploding an archive storing the module.

3. The method of claim 1, wherein:
the Java server runs on a system having restrictions on a number of processes that can access a file; and
the retrieval action comprises copying the file storing the module.

4. The method of claim 1, wherein the file type of the file storing the module is an archived Enterprise ARchive (EAR).

5. The method of claim 4, wherein the retrieval action comprises exploding the file storing the module.

6. The method of claim 1, wherein the file type of the file storing the module is a Java ARchive (JAR).

7. The method of claim 6, wherein the retrieval action comprises exploding the file storing the module.

8. The method of claim 1, wherein the file type of the file storing the module is an exploded Enterprise ARchive (EAR).

9. The method of claim 8, wherein the retrieval action comprises directing the module to copy resources within the module.

10. The method of claim 1, wherein the file type of the file storing the module is an exploded Java ARchive (JAR).

11. The method of claim 10, wherein the retrieval action comprises directing the module to copy resources within the module.

12. A machine readable medium having instructions stored thereon that when executed by a processor cause a system to:
generate a file interface in a Java server, the file interface configured to receive requests to retrieve modules stored in a plurality of file types;
receive at the file interface a request from a container for a module, the request including a resource identifier for the module and a path for the module;
determine a retrieval action to be performed for a file type of a file storing the module; and
perform the retrieval action on the file storing the module.

13. The machine readable medium of claim 12, wherein the retrieval action comprises exploding an archive storing the module.

14. The machine readable medium of claim 12, wherein:
the Java server runs on a system having restrictions on a number of processes that can access a file; and
the retrieval action comprises copying the file storing the module.

15. The machine readable medium of claim 12, wherein the file type of the file storing the module is an archived Enterprise ARchive (EAR).

16. The machine readable medium of claim 15, wherein the retrieval action comprises exploding the file storing the module.

17. The machine readable medium of claim 12, wherein the file type of the file storing the module is a Java ARchive (JAR).

18. The machine readable medium of claim 17, wherein the retrieval action comprises exploding the file storing the module.

19. The machine readable medium of claim 12, wherein the file type of the file storing the module is an exploded Enterprise ARchive (EAR).

20. The machine readable medium of claim 19, wherein the retrieval action comprises directing the module to copy resources within the module.

21. The machine readable medium of claim 12, wherein the file type of the file storing the module is an exploded Java ARchive (JAR).

22. The machine readable medium of claim 21, wherein the retrieval action comprises directing the module to copy resources within the module.

23. A system for retrieving modules within a Java server, the system comprising:
a file system storing modules in files having a plurality of file types;
a container configured to submit a request for a module, the request including a resource identifier for the module and a path for the module;
a file interface configured to:
receive the request;
determine a retrieval action to be performed for a file type of a file storing the module; and
perform the retrieval action on the file storing the module.

24. The system of claim 23, wherein the retrieval action comprises exploding an archive storing the module.

25. The system of claim 23, wherein:
the Java server runs on a system having restrictions on a number of processes that can access a file; and
the retrieval action comprises copying the file storing the module.

26. The system of claim 23, wherein the file type of the file storing the module is an archived Enterprise ARchive (EAR).

27. The system of claim 26, wherein the retrieval action comprises exploding the file storing the module.

28. The system of claim 23, wherein the file type of the file storing the module is an Java ARchive (JAR).

29. The system of claim 28, wherein the retrieval action comprises exploding the file storing the module.

30. The system of claim 23, wherein the file type of the file storing the module is an exploded Enterprise ARchive (EAR).

31. The system of claim 30, wherein the retrieval action comprises directing the module to copy resources within the module.

32. The system of claim 23, wherein the file type of the file storing the module is an exploded Java ARchive (JAR).

33. The system of claim 32, wherein the retrieval action comprises directing the module to copy resources within the module.
